(19) United States
(12) Patent Application Publication
(10) Pub. No.: US 2026/0178913 A1
(43) Pub. Date: Jun. 25, 2026

(54) SELF-SUPERVISED ARTIFICIAL INTELLIGENCE FOR MEDICAL IMAGE NOISE REDUCTION

(71) Applicant: Mayo Foundation for Medical Education and Research, Rochester, MN (US)

(72) Inventors: Andrew D. Missert, Rochester, MN (US); Matthew R. Callstrom, Rochester, MN (US); Panagiotis Korfiatis, Rochester, MN (US); Timothy L. Kline, Rochester, MN (US); Wenchao Cao, Rochester, MN (US)

(21) Appl. No.: 19/126,886

(22) PCT Filed: Nov. 3, 2023
(86) PCT No.: PCT/US2023/078687

§ 371 Date: May 2, 2025

Related U.S. Application Data
(60) Provisional application No. 63/422,911, filed on Nov. 4, 2022.

(51) Int. Cl. G06N 3/084

(52) U.S. Cl. CPC G06N 3/084

(57) ABSTRACT

Machine learning models are trained for denoising medical images using self-supervised learning. Image patches are extracted from uniform regions-of-interest in the medical images (204,206), from which higher noise image patches can be created (210). The extracted image patches and created higher noise image patches are paired to create a training data set. A neural network is trained on the training data set (212), and the medical images are input to the trained neural network to generate denoised medical images (214).

### BACKGROUND

Medical imaging produces image representations of the human body for diagnosis and treatment of diseases, and is a critical component of modern healthcare. Due to the physical limitations of imaging systems, noise is an important image quality concern for all clinical imaging modalities. This especially true for modalities that use ionizing radiation, such as computed tomography (“CT”), where concern regarding the patient's exposure necessitates some level of compromise between noise and image quality.

The past decade has seen significant advances in artificial intelligence (“AI”) technologies and applications to medical imaging. This includes a wide range of “denoising” applications, which aim to reduce noise in medical images without obfuscating anatomic details. When properly optimized, AI-based denoising greatly outperforms classical approaches. This can significantly enhance the clinically utility of medical images in a variety of ways, including improved spatial resolution, increased detectability of low-contrast features, lower radiation dose, and a more efficient clinical workflows. A major obstacle to practical realization of these enhancements is that the AI-based denoising applications perform best when applied narrowly to data similar to the data used for model optimization. Given the heterogeneity of clinical imaging data, this creates a constant need to optimize and fine-tune to different configurations, which requires data that may be difficult to procure. For example, deep-learning-based CT image denoising can reduce noise while maintaining a high level of anatomic detail. However, optimizing denoising models using supervised learning requires access to proprietary data that is not typically archived in clinical records. This presents a practical problem for implementation, since denoising models must be frequently fine-tuned to different reconstruction conditions to maintain optimal performance on varied clinical data.

Thus, current state-of-the-art methods for medical image denoising require paired (high-noise, low-noise) images in order to perform model optimization. A significant problem with this supervised learning approach is that it is not straightforward to produce such training examples. A common approach to overcoming this limitation is to simulate additional noise in a clinical image, but this requires having significant a priori knowledge of the desired noise characteristics, as well as the complete image reconstruction chain. In many cases it is not feasible to realistically simulate noise for clinical imaging systems, since the raw data and image reconstruction chain is proprietary to the device manufacturer.

As a result of these difficulties, unsupervised methods have been proposed for optimizing AI denoising models. However, these approaches also have significant drawbacks. For example, many popular techniques, such as Noise2Noise, only work if the image noise is spatially uncorrelated, which is not the case for medical image modalities. Furthermore, the overall performance of the denoising model is typically reduced compared to fully supervised methods. This creates a need for performant techniques that can be built from large amounts of unlabeled medical image data to optimize AI denoising models.

### SUMMARY OF THE DISCLOSURE

The present disclosure addresses the aforementioned drawbacks by providing a method for generating a denoised medical image. The method includes accessing medical image data with a computer system, where the medical image data include medical images acquired from a subject using a medical imaging system. Training data are generated from the medical image data using the computer system, where the training data include and/or are derived from image patches extracted from uniform regions-of-interest in the medical images of the medical image data. A neural network is trained on the training data using the computer system, generating a trained neural network as an output. The trained neural network is trained on the training data to generate denoised medical images. Denoised medical image data are then generated by inputting the medical image data to the trained neural network, generating an output as the denoised medical image data. The denoised medical image data include denoised medical images having reduced noise relative to the medical images of the medical image data.

It is another aspect of the present disclosure to provide a computer-implemented method for training a neural network for medical image denoising. The method includes accessing a set of medical images acquired from a subject using a medical imaging system, and extracting image patches from the medical images. The image patches are extracted from uniform regions-of-interest in the medical images. Signal information is removed from the image patches to create uniform noise patches. High-noise image patches are generated by combining the uniform noise patches with the image patches extracted from the medical images. A training set is created, where the training set includes the image patches and the high-noise image patches. The neural network is then trained using the training set.

The foregoing and other aspects and advantages of the present disclosure will appear from the following description. In the description, reference is made to the accompanying drawings that form a part hereof, and in which there is shown by way of illustration one or more embodiments. These embodiments do not necessarily represent the full scope of the invention, however, and reference is therefore made to the claims and herein for interpreting the scope of the invention.

### BRIEF DESCRIPTION OF THE DRAWINGS

FIG. 1 is a workflow illustrating a self-supervised medical image denoising process that include a uniform patch extraction stage, a denoising model training stage, and a denoising model inference stage.

FIG. 2 is a flowchart illustrating example steps for processing routine medical images to create denoised medical images using a denoising model trained using uniform region-of-interest (“ROI”)-informed self-supervised learning.

FIG. 3 shows examples of uniform image patches extracted from medical images.

FIG. 4 is a flowchart setting forth the steps of an example method for denoising medical image data using a neural network trained using a self-supervised learning technique.

FIG. 5 is a flowchart setting forth the steps of an example method for training a neural network for medical image denoising using self-supervised learning.

FIG. 6 shows a visual comparison on a whole image by using different patch denoising strategies. The display window is [−180 240] HU for the patient images of the first row, [−10 10] HU for the second and third rows.

FIG. 7 is a block diagram of an example system for self-supervised medical image denoising.

FIG. 8 is a block diagram of example components that can implement the system of FIG. 7.

### DETAILED DESCRIPTION

Described here systems and method for training machine learning algorithms or models to generate denoised medical images using a self-supervised and/or unsupervised learning approach. The trained machine learning algorithms or models can then be implemented to generate denoised medical images.

In general, the systems and methods described in the present disclosure utilize self-supervised and/or unsupervised learning for medical image denoising in the image domain, and do not require obtention of ground truth high-dose images. The disclosed systems and methods utilize direct measurements of noise on uniform regions of the medical images acquired from the patient-of-interest. Because the systems and methods operate in the image domain, the technical solution they provide is scanner-agnostic, and the direct noise measurements make the disclosed systems and methods easier to implement.

It is not uncommon for medical images to include regions that have an approximately uniform contrast level. These homogeneous, or uniform, regions-of-interest (“ROIs”) arise naturally from anatomical regions with homogeneous physical properties. For example, a CT image without intravenous contrast injection can typically include uniform ROIs in the bladder and large blood vessels.

Within these uniform ROIs, the image features are dominated by the noise of the imaging system. It is an advantage of the systems and methods described in the present disclosure to provide an optimization framework that leverages the fact that large collections of medical images contain numerous uniform ROIs. Using these images, a neural network or other machine learning algorithm can be trained to denoise medical images using a self-supervised, or otherwise unsupervised, learning approach. In this way, the systems and methods described in the present disclosure can advantageously optimize denoising models for medical images without advanced, a priori knowledge of the noise model and/or without proprietary raw data from the imaging device. Furthermore, no additional data (e.g., phantom scans, special image reconstructions) are required. Rather, the systems and methods can operate on a single input of a suitable quantity of clinical images, which are readily available as a part of routine clinical practice. This makes the disclosed systems and methods much more feasible to tailor denoising models that achieve high performance on clinical images.

It is an aspect of the present disclosure to provide a self-supervised learning paradigm for medical image denoising that can be implemented using only routine clinical images. For example, a two-phase processing pipeline can be implemented, featuring a sequential convolutional neural network (“CNN”), or other suitable classifier algorithm or model, for uniform patch classification, and a residual CNN autoencoder for denoising. In the first phase, a binary classifier CNN can sort image patches cropped from clinical data into uniform and non-uniform classes, as described above. In the second phase, the uniform patches can be normalized, resized, and superimposed on the non-uniform patches to construct a data set for optimizing a denoising autoencoder or other neural network or machine learning model trained and optimized for denoising medical images. In an example study, the disclosed framework was applied to low-dose CT images and compared to other supervised methods as well as the corresponding routine-dose CT images using various quantitative metrics. These results together with qualitative comparisons of anatomic regions demonstrated that the disclosed framework can reduce the noise in low-dose CT images to levels below that for routine-dose CT images while maintaining anatomic details, and can perform similarly to fully supervised methods without the drawbacks of those techniques.

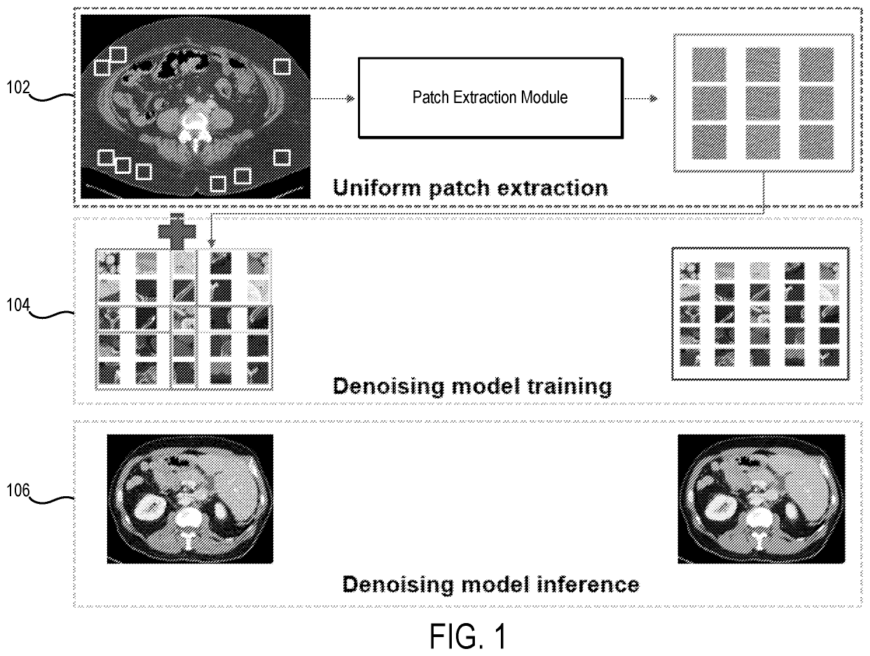

FIG. 1 provides an overview of the uniform-patch-based denoising framework. In a patch extraction stage 102, patient image patches are first sent to a binary classifier that is configured to classifying the image patches into “uniform” and “non-uniform” patch sets, as described above. The extracted uniform patches from the patient images are then normalized and randomly superimposed on the non-uniform patches to simulate LD inputs for optimizing the denoising model in a denoising model training stage 104. The trained denoising model is then used in a denoising model inference stage 106, in which a new patient image is input to the trained denoising model, generating an output as a denoised medical image.

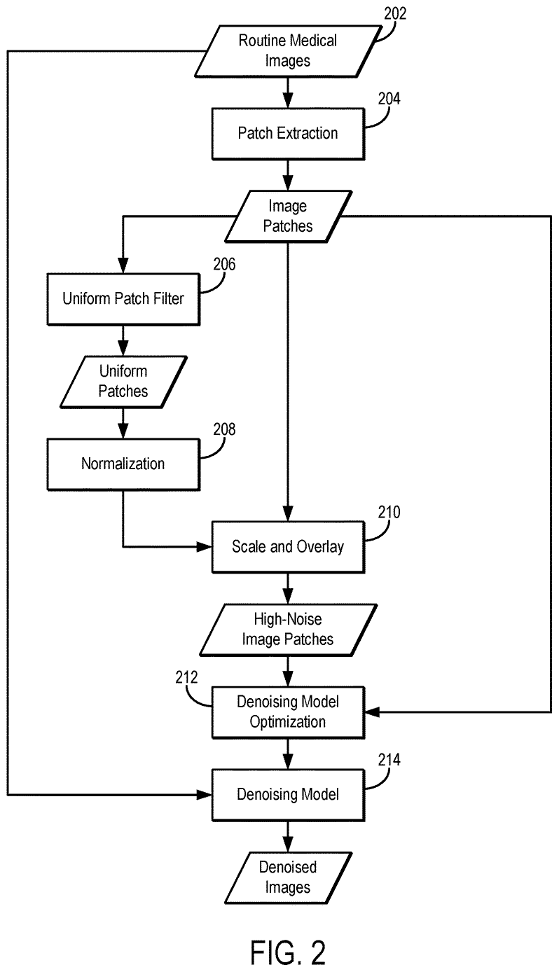

As a non-limiting example, the method can generally proceed as illustrated in FIG. 2. A large dataset of unlabeled medical images for a specific modality (e.g., computed tomography (“CT”)) is accessed with a computer system, as indicated at step 202. Random regions with a fixed pixel size (i.e., “patches”) are extracted from the image dataset, as indicated at step 204.

The extracted patches are then classified as either uniform (e.g., homogeneous) patches or non-uniform (e.g., inhomogeneous, heterogeneous) patches. For example, the patches can be input to a trained neural network, machine learning algorithm or other artificial intelligence (“AI”) model that has been trained or otherwise optimized to classify image patches as either uniform or non-uniform. For instance, a uniform patch filter can be implemented using a machine learning algorithm or model, as indicated at step 206. Additionally or alternatively, image patches can be manually labelled or annotated as uniform or non-uniform patches. The manually labelled or annotated patches can be stored for use in a supervised learning training of a machine learning algorithm with little training required.

The mean values are subtracted from the uniform image patches in a normalization process, as indicated at step 208. Because the uniform image patches are approximately uniform, this subtraction removes the “signal” component from the patches and leaves only the noise component. In this way, the uniform image patches can be converted to uniform noise patches. The noise patches may also be augmented and resized arbitrarily using, for example, random phase noise.

Image pairs containing high-noise and low-noise image patches are then formed, as indicated at step 210. The high-noise patches can be generated by adding a noise patch obtained from step 208 with appropriate scale factors. A denoising neural network, machine learning algorithm, or other AI model is then trained or otherwise optimized at step 212 using the image pairs formed in step 210 as training data. The trained denoising network, algorithm, or model can then be used to generate denoised medical images by inputting new, noisy medical images to the trained network, algorithm, or model, as indicated at step 214.

A non-limiting example for denoising computed tomography (“CT”) images is now described. Deep learning-based CT image denoising aims to find the optimal parameters \hat{θ} for a model g(x,θ) such that g maps a low-dose CT image (x_{LD}) to an output image (y) that approximates the corresponding routine-dose CT image (x_{RD}):

$$g ( {x}_{LD} , \hat{θ} ) = y \approx {x}_{R D} . \qquad ( 1 )$$

The standard approach is to generate a training data set that includes examples of paired images

$$( {x}_{L D}^{i} , {x}_{RD}^{i} )$$

and to then optimize θ using supervised learning with a suitable loss function.

When projection domain data is available,

$${x}_{LD}^{i}$$

can be directly simulated from

$${x}_{R D}^{i} .$$

This approach provides the most accurate simulation of CT noise, but is infeasible or otherwise impractical in most settings since the raw projection data is proprietary and not saved in the routine clinical practice.

The systems and methods described in the present disclosure address these limitations by using noise patches superimposed on clinical image patches to simulate low-dose CT images. In some embodiments, rather than performing dedicated phantom scans, the noise patches can be extracted from uniform regions-of-interest (“ROIs”) in the original clinical data. As a non-limiting example, given N routine clinical CT exams, all image patches p of specified pixel size are extracted to form a data set P that includes M patches. The patches are then separated into two subsets: uniform patches (P_{U}) and non-uniform patches (P_{NU}).

As an example, the uniform patch set and the non-uniform patch set can be formed by using an auxiliary patch classifier f(x, θ). This allows for the construction of a training data set:

$$D = \{ ( {x}_{i} + α ( {x}_{j} + {μ}_{j} ) , {x}_{i} ) ∀ {x}_{i} ∈ {P}_{NU} , ∀ {x}_{j} ∈ {P}_{U} \} ; \qquad ( 2 )$$

where μ represents the mean of the pixel values in patch xⱼ, and α is a scaling factor that controls the magnitude of the added noise. Notably, this training data set D does not require any a priori knowledge from the CT scanner(s) used to acquire the images. Rather, the training data set can be advantageously composed of only unlabeled images, which are routinely available in clinical archives.

As noted above, uniform ROIs are not uncommon in clinical CT images since some tissues have approximately homogeneous linear attenuation coefficients. In these uniform ROIs, the mean Hounsfield unit (“HU”) value can be considered the “signal” component of the image, and any variance within the region can be attributed to noise. By extracting uniform patches from uniform ROIs in patient images and subtracting off the mean, estimates of pure CT noise patches can be generated without having to use a phantom scanning technique.

Because many different soft tissues exhibit a similar contrast, using a simple threshold-based method often fails to identify uniform patches. Therefore, manual selection of these patches can be performed. To avoid using manual selection, it is an advantage of the systems and methods described in the present disclosure to use an auxiliary CNN f(x, θ) for uniform patch identification.

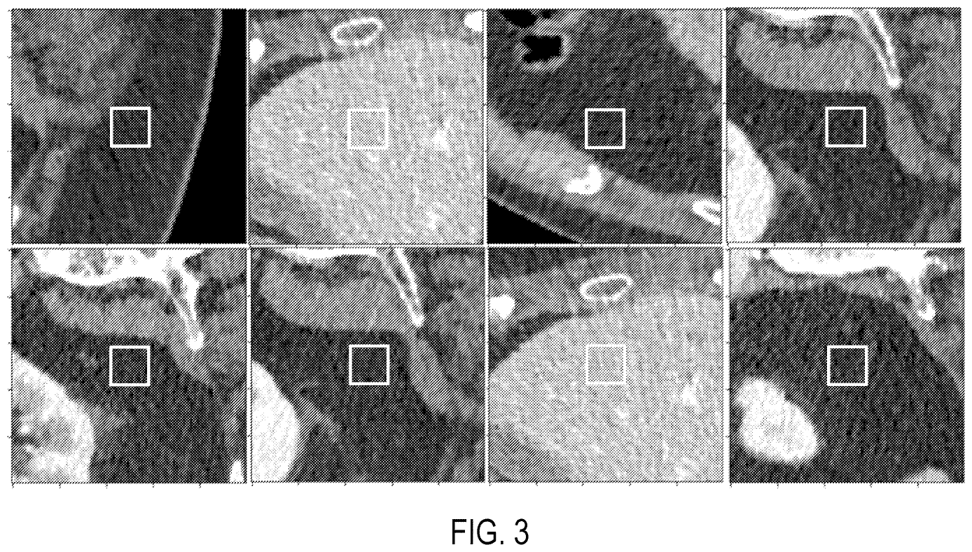

A natural trade-off exists between the patch size and the prevalence of uniform patches in clinical data. As a non-limiting example, a patch size of 16×16 can be used to provide a balance between spatial context and the overall number of uniform patches. FIG. 3 shows an example of uniform patches identified using the patch classifying CNN described in the present disclosure, in which uniform patches are demarcated by yellow boxes in the respective clinical images.

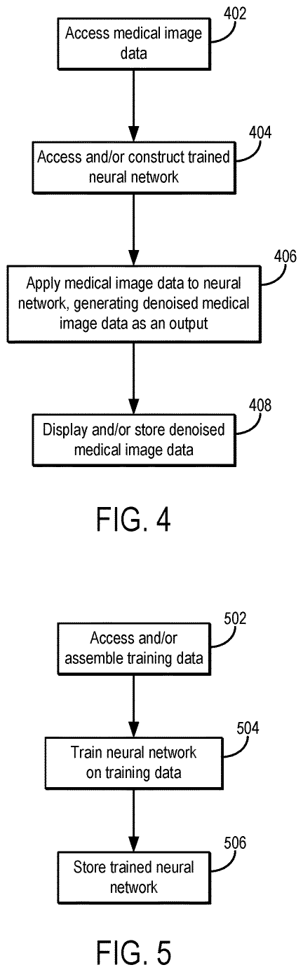

Referring now to FIG. 4, a flowchart is illustrated as setting forth the steps of an example method for generating denoised medical images using a suitably trained neural network or other machine learning algorithm. As will be described, the neural network or other machine learning algorithm takes medical images (e.g., noisy medical images) as input data and generates denoised medical images as output data. As an example, the neural network or other machine learning algorithm can be trained in an unsupervised or self-supervised manner, as will be described in more detail below.

The method includes accessing medical image data with a computer system, as indicated at step 402. Accessing the medical image data may include retrieving such data from a memory or other suitable data storage device or medium. Additionally or alternatively, accessing the medical image data may include acquiring such data with a medical imaging system and transferring or otherwise communicating the data to the computer system, which may be a part of the medical imaging system.

The medical image data may generally include medical images acquired with a suitable medical imaging system. As a non-limiting example, the medical images may be CT images acquired with a CT imaging system. In some implementations, the CT images are low-dose CT images, which will generally have a higher noise content that routine dose CT images. The medical image data may also include medical images acquired using other medical imaging modalities. For instance, the medical image data can include images acquired with a magnetic resonance imaging (“MRI”) system, a positron emission tomography (“PET”) system, a single photon emission computed tomography (“SPECT”) system, an ultrasound system, and so on.

A trained neural network (or other suitable machine learning algorithm) is then accessed and/or constructed with the computer system, as indicated at step 404. Accessing the trained neural network may include accessing network parameters (e.g., weights, biases, or both) that have been optimized or otherwise estimated by training the neural network on training data. In some instances, retrieving the neural network can also include retrieving, constructing, or otherwise accessing the particular neural network architecture to be implemented. For instance, data pertaining to the layers in the neural network architecture (e.g., number of layers, type of layers, ordering of layers, connections between layers, hyperparameters for layers) may be retrieved, selected, constructed, or otherwise accessed.

As described above, the neural network may be trained on training data extracted from the medical image data acquired from the subject using a self-supervised learning technique. In these instances, accessing the trained neural network with the computer system can include training the neural network using the medical image data as the training data, as described below in more detail.

In general, the neural network is trained, or has been trained, on training data in order to denoise a medical image. As noted above, the neural network can advantageously be trained using unsupervised and/or self-supervised learning techniques, such that an extensive training data set of paired input (noisy) and output (denoised) medical images is not needed to generated the trained neural network.

An artificial neural network generally includes an input layer, one or more hidden layers (or nodes), and an output layer. Typically, the input layer includes as many nodes as inputs provided to the artificial neural network. The number (and the type) of inputs provided to the artificial neural network may vary based on the particular task for the artificial neural network.

The input layer connects to one or more hidden layers. The number of hidden layers varies and may depend on the particular task for the artificial neural network. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. In some configurations, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is generally associated with an activation function. The activation function defines how the hidden layer is to process the input received from the input layer or from a previous input or hidden layer. These activation functions may vary and be based on the type of task associated with the artificial neural network and also on the specific type of hidden layer implemented.

Each hidden layer may perform a different function. For example, some hidden layers can be convolutional hidden layers which can, in some instances, reduce the dimensionality of the inputs. Other hidden layers can perform statistical functions such as max pooling, which may reduce a group of inputs to the maximum value; an averaging layer; batch normalization; and other such functions. In some of the hidden layers each node is connected to each node of the next hidden layer, which may be referred to then as dense layers. Some neural networks including more than, for example, three hidden layers may be considered deep neural networks.

The last hidden layer in the artificial neural network is connected to the output layer. Similar to the input layer, the output layer typically has the same number of nodes as the possible outputs.

The medical image data are then input to the trained neural network, generating output as denoised medical image data, as indicated at step 406. The denoised medical image data include medical images of the same imaging modality type as the input medical image data, but with less noise than the input medical image data. For instance, when the medical image data contained low-dose CT images, the output data can include denoised medical image data containing CT images having reduced noise. As a non-limiting example, the denoised medical image data may include CT images having a noise level consistent with a routine dose CT image.

The denoised medical image data generated by inputting the medical image data to the trained neural network(s) can then be displayed to a user, stored for later use or further processing, or both, as indicated at step 408.

Referring now to FIG. 5, a flowchart is illustrated as setting forth the steps of an example method for training one or more neural networks (or other suitable machine learning algorithms) on training data, such that the one or more neural networks are trained to receive medical image data as input data in order to generate denoised medical image data as output data, where the denoised medical image data are indicative of medical images having reduced noise relative to the input medical image data.

In general, the neural network(s) can implement any number of different neural network architectures. For instance, the neural network(s) could implement a convolutional neural network, a residual neural network, or the like. Alternatively, the neural network(s) could be replaced with other suitable machine learning or artificial intelligence algorithms, such as those based on supervised learning, unsupervised learning, deep learning, ensemble learning, dimensionality reduction, and so on.

The method includes accessing and/or assembling training data with a computer system, as indicated at step 502. Accessing the training data may include retrieving such data from a memory or other suitable data storage device or medium. Alternatively, accessing the training data may include acquiring such data with a medical imaging system and transferring or otherwise communicating the data to the computer system. In general, the training data can include noisy medical images.

The method can include assembling the training data from medical images using a computer system. This step may include assembling the medical images into an appropriate data structure on which the neural network or other machine learning algorithm can be trained.

As described above, assembling the training data may include extracting noise patches from uniform ROIs in the medical images. Additionally or alternatively, assembling the training data may include combining the extracted noise patches with the medical image. For instance, assembling the training data may include extracting uniform patches (e.g., noise patches from uniform ROIs in the medical images) and non-uniform patches. The uniform patches can be normalized and randomly superimposed on the non-uniform patches to form the training data set. Additionally or alternatively, the uniform patches may also be augmented (e.g., by resizing the uniform patches) using established techniques in sample-based texture synthesis (e.g., random phase). As described above, the uniform patches can be manually extracted from the medical images, or can be extracted using an automated process. As one non-limiting example, a neural network or other machine learning algorithm can be trained as a patch classifier to extract both uniform and non-uniform patches from the medical images.

One or more neural networks (or other suitable machine learning algorithms) are then trained on the training data, as indicated at step 504. In general, the neural network can be trained by optimizing network parameters (e.g., weights, biases, or both) based on minimizing a loss function. As one non-limiting example, the loss function may be a mean squared error loss function.

Training a neural network may include initializing the neural network, such as by computing, estimating, or otherwise selecting initial network parameters (e.g., weights, biases, or both). During training, an artificial neural network receives the inputs for a training example and generates an output using the bias for each node, and the connections between each node and the corresponding weights. For instance, training data can be input to the initialized neural network, generating output as denoised medical image data. The artificial neural network then analyzes the generated output in order to evaluate the quality of the denoised medical image data. For instance, the denoised medical image data can be passed to a loss function to compute an error. The current neural network can then be updated based on the calculated error (e.g., using backpropagation methods based on the calculated error). For instance, the current neural network can be updated by updating the network parameters (e.g., weights, biases, or both) in order to minimize the loss according to the loss function. The training continues until a training condition is met. The training condition may correspond to, for example, a predetermined number of training examples being used, a minimum accuracy threshold being reached during training and validation, a predetermined number of validation iterations being completed, and the like. When the training condition has been met (e.g., by determining whether an error threshold or other stopping criterion has been satisfied), the current neural network and its associated network parameters represent the trained neural network. Different types of training processes can be used to adjust the bias values and the weights of the node connections based on the training examples. The training processes may include, for example, gradient descent, Newton's method, conjugate gradient, quasi-Newton, Levenberg-Marquardt, among others.

The artificial neural network can be constructed or otherwise trained based on training data using one or more different learning techniques, such as unsupervised learning and self-supervised learning. Additionally or alternatively, other learning schemes can be used, including supervised learning, reinforcement learning, ensemble learning, active learning, transfer learning, or other suitable learning techniques for neural networks.

The one or more trained neural networks are then stored for later use, as indicated at step 506. Storing the neural network(s) may include storing network parameters (e.g., weights, biases, or both), which have been computed or otherwise estimated by training the neural network(s) on the training data. Storing the trained neural network(s) may also include storing the particular neural network architecture to be implemented. For instance, data pertaining to the layers in the neural network architecture (e.g., number of layers, type of layers, ordering of layers, connections between layers, hyperparameters for layers) may be stored.

In an example study, low-dose CT images were used as a training data set to train and test the neural network-based denoising techniques described in the present disclosure. The data set included multiple abdomen CT scans performed with normal dose levels. These examinations were referred to as routine dose (“RD”) images. In addition, a simulated low-dose (“LD”) examination was generated for each case using a projection-domain noise insertion method to simulate 25% of the original dose level. The LD images from a subset of 24 subjects scanned with a 400 mm FOV was utilized in the experiments. The images were randomly divided into three groups: training (12), validation (6), and testing (6).

Three training experiments were performed, each using different patch overlays for the validation: (1) training with 64×64 noise patches; (2) training with 16× 16 noise patches; and (3) training with 16×16 patient uniform patches. A data set of 100,000 random non-uniform patches of the corresponding pixel size as used as the reference RD images for each configuration. Details of the training studies are described in Table 1.

TABLE 1
Training studies and the corresponding data configurations.
Here noise patches come from projection-domain noise
simulation, whereas uniform patches come from uniform
regions in the original patient images

| Name | Patch Size | Input | Target |
|---|---|---|---|
| 64 × 64 Noise | 64 × 64 × 5 | RD patch + noise patch | RD |
| 16 × 16 Noise | 16 × 16 × 5 | RD patch + noise patch | RD |
| 16 × 16 Uniform Patch | 16 × 16 × 5 | RD + uniform patch | RD |

A residual CNN architecture that was based on U-net was used in each study. The model was implemented in TensorFlow 2.3.0 and optimized using the ADAM optimizer with a step decay learning rate from 1e-3 to 1e-5, and batch size of 32 for 100 epochs. The models were trained on one NVIDIA Tesla V100 GPU 32 GB.

CNN performance was evaluated based on qualitative and quantitative comparisons. Using the RD image as the ground truth reference, the root means square error (“RMSE”), peak signal-to-noise ratio (“PSNR”), and structural similarity (“SSIM”) were calculated. Moreover, regional comparisons of the standard deviation (“SD”) inside an abdominal aorta ROI, contrast-to-noise ratio (“CNR”) inside hepatic ROIs were performed to evaluate the noise level and low contrast detectability. Comparisons were also made to a pre-trained CNN that was optimized using projection-domain noise insertion, which represents a state-of-the-art benchmark for fully supervised approaches.

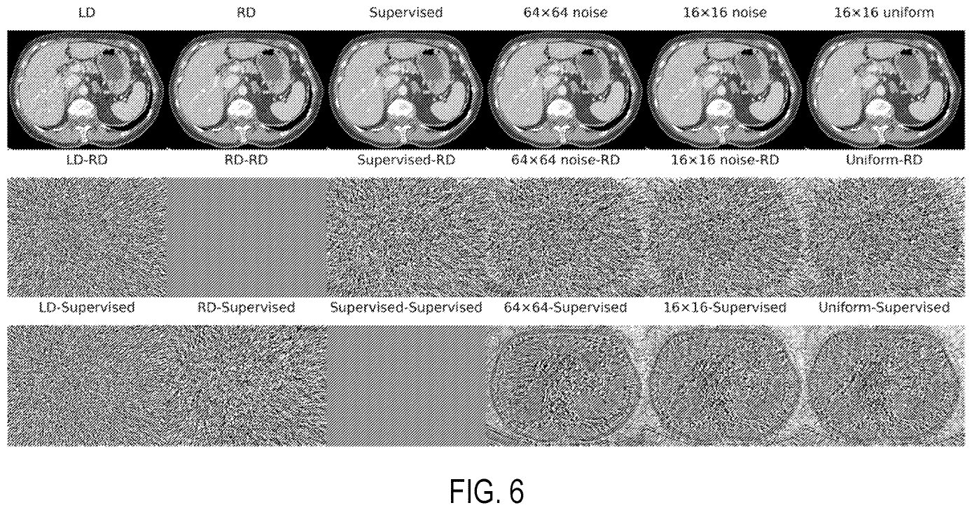

The denoising results for LD patient images from the test set were compared for the different methods. Example images are shown in the first row of FIG. 6. The second and third row of FIG. 6 present the difference image of each method versus the RD image and the result from the pre-trained supervised CNN. All approaches visibly reduce noise in the LD images. The differences between the denoised results and the corresponding RD images show that anatomic details are well-maintained. Some residual low-frequency bias was present in the results obtained using 16×16 patches. This bias is much smaller than the magnitude of typical noise fluctuations, however. It was observed that similar performance was achieved when comparing training with 16×16 noise patches to using patient uniform patches. This indicated that there is practical value of the disclosed systems and methods in common cases where realistic noise simulation is unavailable.

The usefulness of the disclosed systems and methods is further supported by the quantitative results provided in Table 2, which show that the uniform-patch-based method achieves comparable, and sometimes better, results versus the other supervised methods.

TABLE 2
Quantitative comparison of image quality metrics
evaluated against the corresponding RD images

| | RMSE | SSIM | PSNR |
|---|---|---|---|
| LD | 42.90 | 0.79 | 33.57 |
| Supervised CNN | 17.32 | 0.96 | 41.45 |
| 64 × 64 Noise Patch | 17.31 | 0.96 | 41.46 |
| 16 × 16 Noise Patch | 18.03 | 0.95 | 41.10 |
| 16 × 16 Uniform Patch | 18.51 | 0.95 | 40.87 |

This example study validated the uniform-patch-based, self-supervised optimization method for medical image denoising described in the present disclosure. Qualitative and quantitative evaluations showed that the disclosed systems and methods can reduce noise in LDCT images to levels below those of RDCT images, while maintaining a high level of anatomic detail. The results of the disclosed systems and methods are comparable to those of supervised methods that use projection-domain noise insertion, but the proposed systems and methods do not require access to raw projection data. The disclosed systems and methods are, therefore, more practical to implement, since the denoising models can be optimized using only images collected through routine clinical practice. This can advantageously enable more widespread application of CT image denoising with the potential for improved spatial resolution and lower patient dose.

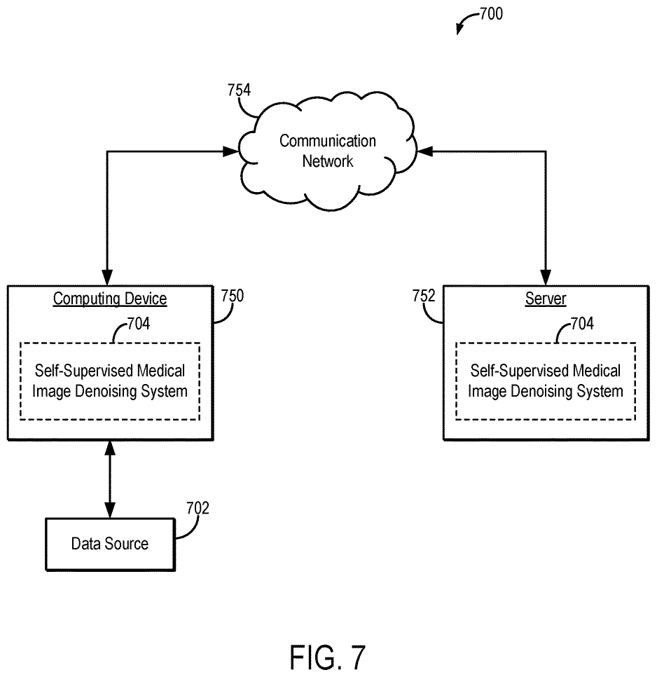

Referring now to FIG. 7, an example of a system 700 for denoising medical images, such as low-dose CT images, in accordance with some embodiments of the systems and methods described in the present disclosure is shown. As shown in FIG. 7, a computing device 750 can receive one or more types of data (e.g., medical image data, training data) from data source 702. In some embodiments, computing device 750 can execute at least a portion of a self-supervised medical image denoising system 704 to denoise medical images received from the data source 702.

Additionally or alternatively, in some embodiments, the computing device 750 can communicate information about data received from the data source 702 to a server 752 over a communication network 754, which can execute at least a portion of the self-supervised medical image denoising system 704. In such embodiments, the server 752 can return information to the computing device 750 (and/or any other suitable computing device) indicative of an output of the self-supervised medical image denoising system 704.

In some embodiments, computing device 750 and/or server 752 can be any suitable computing device or combination of devices, such as a desktop computer, a laptop computer, a smartphone, a tablet computer, a wearable computer, a server computer, a virtual machine being executed by a physical computing device, and so on. The computing device 750 and/or server 752 can also reconstruct images from the data.

In some embodiments, data source 702 can be any suitable source of data (e.g., measurement data, images reconstructed from measurement data, processed medical image data), such as medical imaging system, another computing device (e.g., a server storing measurement data, images reconstructed from measurement data, processed medical image data), and so on. In some embodiments, data source 702 can be local to computing device 750. For example, data source 702 can be incorporated with computing device 750 (e.g., computing device 750 can be configured as part of a device for measuring, recording, estimating, acquiring, or otherwise collecting or storing data). As another example, data source 702 can be connected to computing device 750 by a cable, a direct wireless link, and so on. Additionally or alternatively, in some embodiments, data source 702 can be located locally and/or remotely from computing device 750, and can communicate data to computing device 750 (and/or server 752) via a communication network (e.g., communication network 754).

In some embodiments, communication network 754 can be any suitable communication network or combination of communication networks. For example, communication network 754 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 754 can be a local area network, a wide area network, a public network (e.g., the Internet), a private or semi-private network (e.g., a corporate or university intranet), any other suitable type of network, or any suitable combination of networks. Communications links shown in FIG. 7 can each be any suitable communications link or combination of communications links, such as wired links, fiber optic links, Wi-Fi links, Bluetooth links, cellular links, and so on.

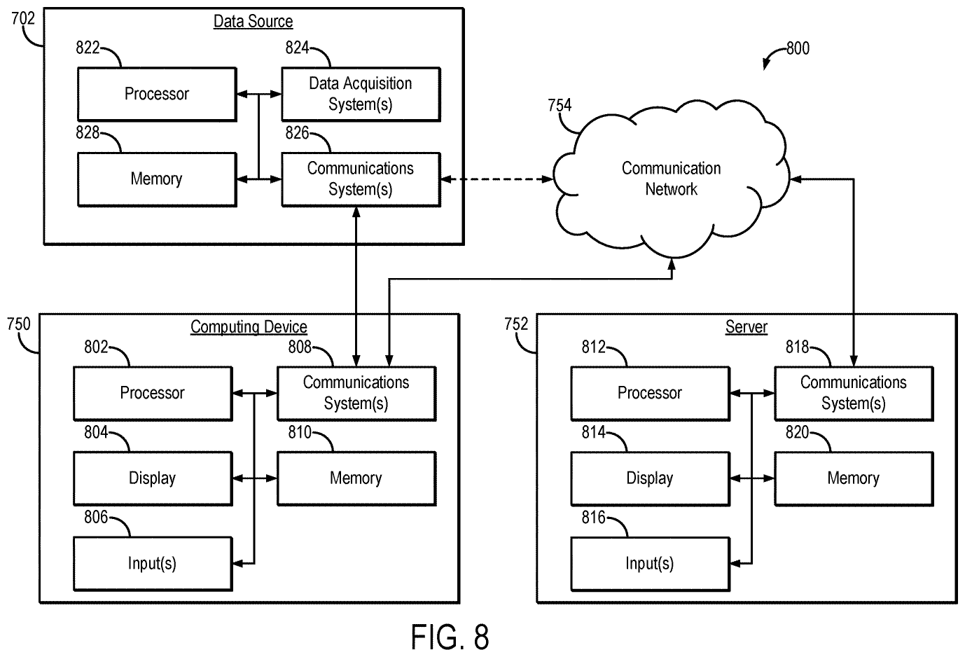

Referring now to FIG. 8, an example of hardware 800 that can be used to implement data source 702, computing device 750, and server 752 in accordance with some embodiments of the systems and methods described in the present disclosure is shown.

As shown in FIG. 8, in some embodiments, computing device 750 can include a processor 802, a display 804, one or more inputs 806, one or more communication systems 808, and/or memory 810. In some embodiments, processor 802 can be any suitable hardware processor or combination of processors, such as a central processing unit (“CPU”), a graphics processing unit (“GPU”), and so on. In some embodiments, display 804 can include any suitable display devices, such as a liquid crystal display (“LCD”) screen, a light-emitting diode (“LED”) display, an organic LED (“OLED”) display, an electrophoretic display (e.g., an “e-ink” display), a computer monitor, a touchscreen, a television, and so on. In some embodiments, inputs 806 can include any suitable input devices and/or sensors that can be used to receive user input, such as a keyboard, a mouse, a touchscreen, a microphone, and so on.

In some embodiments, communications systems 808 can include any suitable hardware, firmware, and/or software for communicating information over communication network 754 and/or any other suitable communication networks. For example, communications systems 808 can include one or more transceivers, one or more communication chips and/or chip sets, and so on. In a more particular example, communications systems 808 can include hardware, firmware, and/or software that can be used to establish a Wi-Fi connection, a Bluetooth connection, a cellular connection, an Ethernet connection, and so on.

In some embodiments, memory 810 can include any suitable storage device or devices that can be used to store instructions, values, data, or the like, that can be used, for example, by processor 802 to present content using display 804, to communicate with server 752 via communications system(s) 808, and so on. Memory 810 can include any suitable volatile memory, non-volatile memory, storage, or any suitable combination thereof. For example, memory 810 can include random-access memory (“RAM”), read-only memory (“ROM”), electrically programmable ROM (“EPROM”), electrically erasable ROM (“EEPROM”), other forms of volatile memory, other forms of non-volatile memory, one or more forms of semi-volatile memory, one or more flash drives, one or more hard disks, one or more solid state drives, one or more optical drives, and so on. In some embodiments, memory 810 can have encoded thereon, or otherwise stored therein, a computer program for controlling operation of computing device 750. In such embodiments, processor 802 can execute at least a portion of the computer program to present content (e.g., images, user interfaces, graphics, tables), receive content from server 752, transmit information to server 752, and so on. For example, the processor 802 and the memory 810 can be configured to perform the methods described herein (e.g., the method of FIG. 4, the method of FIG. 5).

In some embodiments, server 752 can include a processor 812, a display 814, one or more inputs 816, one or more communications systems 818, and/or memory 820. In some embodiments, processor 812 can be any suitable hardware processor or combination of processors, such as a CPU, a GPU, and so on. In some embodiments, display 814 can include any suitable display devices, such as an LCD screen, LED display, OLED display, electrophoretic display, a computer monitor, a touchscreen, a television, and so on. In some embodiments, inputs 816 can include any suitable input devices and/or sensors that can be used to receive user input, such as a keyboard, a mouse, a touchscreen, a microphone, and so on.

In some embodiments, communications systems 818 can include any suitable hardware, firmware, and/or software for communicating information over communication network 754 and/or any other suitable communication networks. For example, communications systems 818 can include one or more transceivers, one or more communication chips and/or chip sets, and so on. In a more particular example, communications systems 818 can include hardware, firmware, and/or software that can be used to establish a Wi-Fi connection, a Bluetooth connection, a cellular connection, an Ethernet connection, and so on.

In some embodiments, memory 820 can include any suitable storage device or devices that can be used to store instructions, values, data, or the like, that can be used, for example, by processor 812 to present content using display 814, to communicate with one or more computing devices 750, and so on. Memory 820 can include any suitable volatile memory, non-volatile memory, storage, or any suitable combination thereof. For example, memory 820 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 820 can have encoded thereon a server program for controlling operation of server 752. In such embodiments, processor 812 can execute at least a portion of the server program to transmit information and/or content (e.g., data, images, a user interface) to one or more computing devices 750, receive information and/or content from one or more computing devices 750, receive instructions from one or more devices (e.g., a personal computer, a laptop computer, a tablet computer, a smartphone), and so on.

In some embodiments, the server 752 is configured to perform the methods described in the present disclosure. For example, the processor 812 and memory 820 can be configured to perform the methods described herein (e.g., the method of FIG. 4, the method of FIG. 5).

In some embodiments, data source 702 can include a processor 822, one or more data acquisition systems 824, one or more communications systems 826, and/or memory 828. In some embodiments, processor 822 can be any suitable hardware processor or combination of processors, such as a CPU, a GPU, and so on. In some embodiments, the one or more data acquisition systems 824 are generally configured to acquire data, images, or both, and can include an MRI system. Additionally or alternatively, in some embodiments, the one or more data acquisition systems 824 can include any suitable hardware, firmware, and/or software for coupling to and/or controlling operations of an MRI system. In some embodiments, one or more portions of the data acquisition system(s) 824 can be removable and/or replaceable.

Note that, although not shown, data source 702 can include any suitable inputs and/or outputs. For example, data source 702 can include input devices and/or sensors that can be used to receive user input, such as a keyboard, a mouse, a touchscreen, a microphone, a trackpad, a trackball, and so on. As another example, data source 702 can include any suitable display devices, such as an LCD screen, an LED display, an OLED display, an electrophoretic display, a computer monitor, a touchscreen, a television, etc., one or more speakers, and so on.

In some embodiments, communications systems 826 can include any suitable hardware, firmware, and/or software for communicating information to computing device 750 (and, in some embodiments, over communication network 754 and/or any other suitable communication networks). For example, communications systems 826 can include one or more transceivers, one or more communication chips and/or chip sets, and so on. In a more particular example, communications systems 826 can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 828 can include any suitable storage device or devices that can be used to store instructions, values, data, or the like, that can be used, for example, by processor 822 to control the one or more data acquisition systems 824, and/or receive data from the one or more data acquisition systems 824; to generate images from data; present content (e.g., data, images, a user interface) using a display; communicate with one or more computing devices 750; and so on. Memory 828 can include any suitable volatile memory, non-volatile memory, storage, or any suitable combination thereof. For example, memory 828 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 828 can have encoded thereon, or otherwise stored therein, a program for controlling operation of data source 702. In such embodiments, processor 822 can execute at least a portion of the program to generate images, transmit information and/or content (e.g., data, images, a user interface) to one or more computing devices 750, receive information and/or content from one or more computing devices 750, receive instructions from one or more devices (e.g., a personal computer, a laptop computer, a tablet computer, a smartphone, etc.), and so on.

In some embodiments, any suitable computer-readable media can be used for storing instructions for performing the functions and/or processes described herein. For example, in some embodiments, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

The present disclosure has described one or more preferred embodiments, and it should be appreciated that many equivalents, alternatives, variations, and modifications, aside from those expressly stated, are possible and within the scope of the invention.

1. A method for generating a denoised medical image, the method comprising:
(a) accessing medical image data with a computer system, the medical image data comprising medical images acquired from a subject using a medical imaging system;
(b) generating training data from the medical image data using the computer system, wherein the training data comprise image patches extracted from uniform regions-of-interest in the medical images of the medical image data;
(c) training a neural network on the training data using the computer system, generating a trained neural network as an output, wherein the trained neural network is trained on the training data to generate denoised medical images;
(d) generating denoised medical image data by inputting the medical image data to the trained neural network, generating an output as the denoised medical image data, wherein the denoised medical image data comprise denoised medical images having reduced noise relative to the medical images of the medical image data.

2. The method of claim 1, wherein the training data are generated by:
extracting the image patches from the uniform regions-of-interest in the medical images of the medical image data;
generating noise patches by removing signal information from the image patches;
generating high-noise image patches by combining the noise patches and the image patches; and
generating the training data by forming pairs of images patches and high-noise image patches.

3. The method of claim 2, wherein the high-noise image patches are generated by scaling the noise patches before combining the noise patches and the image patches.

4. The method of claim 2, wherein the image patches are extracted from the medical images by inputting the medical images to a classifier model, generating an output as extracted image patches.

5. The method of claim 4, wherein the classifier model is configured to extract uniform image patches from uniform regions-of-interest of the medical images and non-uniform image patches from non-uniform regions-of-interest of the medical images.

6. The method of claim 5, wherein the classifier model comprises a convolutional neural network.

7. The method of claim 2, wherein generating the noise patches comprises removing the signal information from the image patches by normalizing the image patches.

8. The method of claim 7, wherein normalizing the image patches comprises calculating a mean of each image patch and subtracting the mean from the corresponding image patch.

9. The method of claim 1, wherein the neural network comprises a residual neural network.

10. The method of claim 1, wherein the medical imaging system is an x-ray computed tomography (CT) system and the medical image data comprise CT images.

11. The method of claim 1, wherein the training data are derived from the image patches extracted from uniform regions-of-interest in the medical images of the medical image data.

12. A computer-implemented method for training a neural network for medical image denoising, the method comprising:
accessing a set of medical images acquired from a subject using a medical imaging system;
extracting image patches from the medical images, wherein the image patches are extracted from uniform regions-of-interest in the medical images;
removing signal information from the image patches to create uniform noise patches;
generating high-noise image patches by combining the uniform noise patches with the image patches extracted from the medical images;
creating a training set comprising the image patches and the high-noise image patches; and
training the neural network using the training set.

13. The method of claim 12, wherein the image patches are extracted from the medical images by inputting the medical images to a classifier model, generating an output as the image patches.

14. The method of claim 13, wherein the classifier model comprises a convolutional neural network that has been trained to classify image patches as corresponding to uniform regions-of-interest or non-uniform regions-of-interest.

15. The method of claim 12, wherein removing the signal information from the image patches comprises computing a mean of each image patch and subtracting the mean from each corresponding image patch.

16. The method of claim 15, further comprising expanding a size of each of the image patches using texture synthesis.

17. The method of claim 12, wherein generating high-noise image patches comprises scaling the noise patches to create scaled noise patches and overlaying the scaled noise patches with the image patches.

18. The method of claim 12, wherein the training data set comprises pairs of image patches and high-noise image patches.

19. The method of claim 12, wherein the neural network is a residual neural network.

20. The method of claim 12, wherein the medical imaging system is an x-ray computed tomography (CT) imaging system and the medical images comprise CT images.
